(19) United States
(12) Patent Application Publication
(10) Pub. No.: US 2009/0061161 A1
(43) Pub. Date: Mar. 5, 2009

(54) Laser patterning of a cross-linked polymer

(76) Inventors: LYNN SHEEHAN, Bamdarrig (IE); KEVIN DOOLEY, Blessington (IE); RORY JORDAN, Dublin (IE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/895,757

(22) Filed: Aug. 27, 2007

(51) Int. Cl. B32B 3/00; B23K 26/06; C03C 15/00

(52) U.S. Cl. 428/172; 216/94; 219/121.73

(57) ABSTRACT

A method of patterning a cross-linked polymer layer includes providing a substrate comprising a cross-linked polymer layer. A laser beam is generated. The laser beam is directed onto a first surface of the polymer layer. Relative movement between the laser beam and the first surface is caused, thereby forming at least one feature on the first surface.

### BACKGROUND

Methods of creating three-dimensional (3D) patterns in photocurable polymers include embossing and photolithography. Embossing has limitations including feature size and topographical feature definition. Photolithographic processes have the disadvantage of being binary, such that material is either removed, or remains, in order to create a two-dimensional (2D) pattern. Photolithography is typically used for creating channels or cavities in the material, but not raised features, such as a 3D stepped feature. To create a 3D stepped feature using photolithography, multiple process steps (coat, expose, develop) are performed.

### SUMMARY

One embodiment provides a method of patterning a cross-linked polymer layer. The method includes providing a substrate comprising a cross-linked polymer layer. A laser beam is generated. The laser beam is directed onto a first surface of the polymer layer. Relative movement between the laser beam and the first surface is caused, thereby forming at least one feature on the first surface.

### BRIEF DESCRIPTION OF THE DRAWINGS

FIG. 1 is a block diagram illustrating a system for patterning a substrate according to one embodiment.

FIGS. 2A-2D are diagrams illustrating cross-sectional views of a substrate patterned by the system shown in FIG. 1 at increasing laser powers according to one embodiment.

FIG. 3 is a graph showing the relationship between laser power and the swelling and ablation of a polymer layer according to one embodiment.

FIG. 4 is a Wyko white light interferometry image of a polymer layer with raised features and cavity features formed by the system shown in FIG. 1 according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

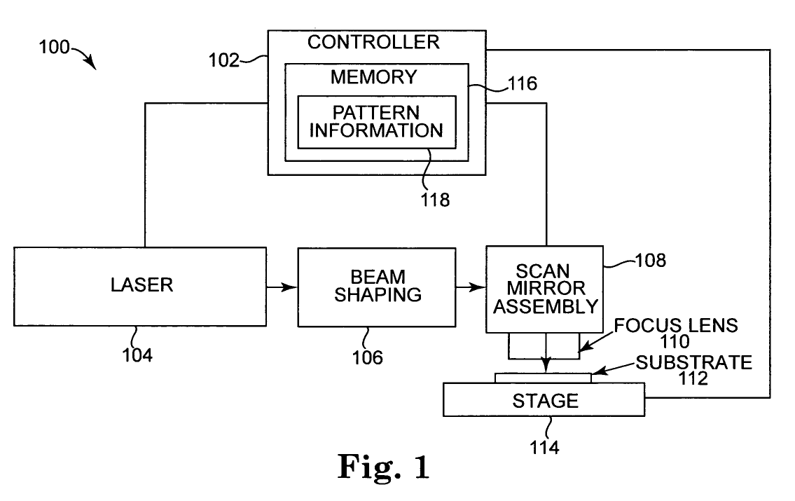

FIG. 1 is a block diagram illustrating a system 100 for patterning a substrate 112 according to one embodiment. System 100 includes controller 102, laser 104, beam shaping assembly 106, scan mirror assembly 108, focus lens 110, and stage 114. The substrate 112 to be patterned is placed on stage 114. Controller 102 causes laser 104 to generate a laser beam, which is output to beam shaping assembly 106. Beam shaping assembly 106 shapes the received laser beam, and outputs a shaped laser beam to scan mirror assembly 108. Controller 102 causes scan mirror assembly 108 to scan the received laser beam across the substrate 112 in a desired pattern. Prior to hitting the substrate 112, the laser beam is focused onto the substrate 112 by focus lens 110. In one embodiment, the focus lens 110 focuses the laser beam to a 1 to 100 micrometer diameter spot on the substrate 112. The diameter of the laser spot is dependent on the focus lens 110 that is used. In one specific embodiment, the focus lens 110 is configured to focus the laser beam to a 10 micrometer diameter spot on the substrate 112.

In one embodiment, scan mirror assembly 108 scans the laser beam across the substrate 112 in two dimensions (e.g., X and Y dimensions parallel to the plane of the substrate 112), thereby allowing two-dimensional patterns to be traced out on the substrate 112. In one embodiment, controller 102 is also configured to cause movement of stage 114, which allows the system 100 to scan the laser beam over larger substrates 112. In another embodiment, the scan mirror assembly 108 is held in a fixed position or is not used, and relative movement between the laser beam and the substrate 112 is caused solely by movement of the stage 114. In yet another embodiment, system 100 is configured to provide vertical movement (e.g., movement in a Z dimension perpendicular to the plane of the substrate 112) between the stage 114 and the optics (e.g., scan mirror assembly 108 and focus lens 110).

In one embodiment, substrate 112 comprises a cured, cross-linked polymer, such as SU8. SU8 is a negative photoresist material. Uncured SU8 can be in liquid or dry film form. Liquid SU8 is coated onto a substrate by spin, spray, or gravure coating. A dry SU8 film can be laminated onto a substrate. SU8 is typically cured using both UV and thermal curing steps. Cured SU8 is a hardened cross-linked polymer, and has a higher mechanical and thermal stability compared to linear polymers.

In one embodiment, substrate 112 is about five micrometers thick. In other embodiments, substrate 112 is thicker or thinner than five micrometers thick. In one embodiment, laser 104 is an 11 W diode pumped solid state pulsed ultraviolet (UV) laser operating at 60 kHz. Laser 104 generates UV laser light with a wavelength of less than 400 nm, and the wavelength is tied to energies that are equal to or higher than the bond energy of the material to be patterned. In one specific embodiment, laser 104 generates UV laser light with a wavelength of 355 nm and a pulse length of about 40 nanoseconds. The energy of the laser beam generated by laser 104 is controlled by controller 102 by changing the laser current. The interaction between the SU8 polymer and the pulsed UV radiation results in the dissociation of certain chemical bonds in the polymer molecules, fragmenting it into smaller units. This mechanism results in two possible outcomes. Above a specific threshold energy, polymer fragments are ablated from the surface of substrate 112. The amount of material that is ablated increases with increasing laser power. At energies just below the ablation threshold, the SU8 polymer swells, resulting in three-dimensional raised structures or features. At such energies, the structure of the bulk polymer is changed due to the formation of new bonds between fragments with insufficient energy to be ejected. The swelling is due to a thermal effect, and the thermal influence is dependent on the laser pulse length. Longer pulse lengths provide more penetration of the thermal heating into the material, and shorter pulse lengths provide less penetration.

In the illustrated embodiment, controller 102 includes memory 116 for storing pattern information 118, which defines the pattern that controller 102 causes the laser beam to trace out on the substrate 112. In one embodiment, the pattern information 118 also includes laser power information, which defines the laser power that is to be used at the various points in the pattern followed by the laser beam. Based on the stored pattern information 118, controller 102 is configured to cause system 100 to scan the laser beam over the substrate 112 in any desired pattern, and form raised features and cavity features in the substrate 112 in a single process step by modifying the laser power above and below the ablation threshold.

In one embodiment, system 100 is configured to create micro-channels and raised microstructures “simultaneously” (i.e., in one process step), by varying the laser energy above and below the ablation threshold while scanning the laser beam across the substrate 112. The laser patterning performed by system 100 according to one embodiment provides a reduction in process steps, compared to conventional photolithographic processes, as it provides for the patterning of features in cured polymers without the need for photo-masks and the associated develop processes. By using particular photocurable polymer materials, and specific light wavelengths, light intensities, and micropatterning techniques, system 100 creates 3D structures in substrate 112 in a single process step in one embodiment.

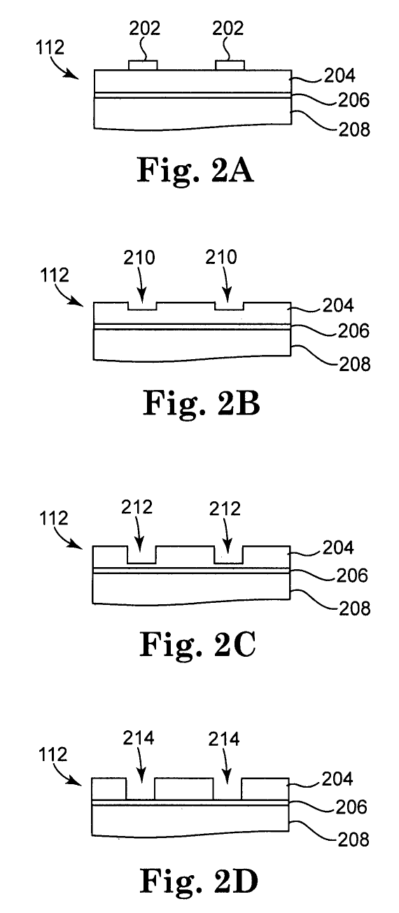

FIGS. 2A-2D are diagrams illustrating cross-sectional views of substrate 112 patterned by the system 100 shown in FIG. 1 at increasing laser powers according to one embodiment. As shown in FIG. 2A, substrate 112 includes a cured, cross-linked polymer layer 204, a metal plating layer 206, and a silicon layer 208. The metal plating layer 206 is formed on the silicon layer 208, and the polymer layer 204 is formed on the metal plating layer 206. In one embodiment, the metal plating layer 206 is stainless steel, gold, or nickel. When laser 104 operates at an energy level below the ablation threshold of polymer layer 204, the laser light results in raised features 202 at the locations where the laser light strikes the polymer layer 204. As shown in FIG. 2A, the raised features 202 are above the surface plane of the polymer layer 204. The height of the raised surfaces 202 is dependent on the thickness of the initial polymer layer 204.

When the power of the laser 104 is increased slightly above the ablation threshold of polymer layer 204, material is ablated from the surface of polymer layer 204, resulting in relatively shallow channels or cavities 210 being formed in the polymer layer 204, as shown in FIG. 2B. When the power of the laser 104 is increased further above the ablation threshold of polymer layer 204, additional material is ablated from the surface of polymer layer 204, resulting in deeper channels or cavities 212 being formed in the polymer layer 204, as shown in FIG. 2C. When the power of the laser 104 is increased even further above the ablation threshold of polymer layer 204, all of the polymer material at the target locations is ablated, resulting in channels or cavities 214 being formed in the polymer layer 204 that extend all the way down to the metal plating layer 206, as shown in FIG. 2D.

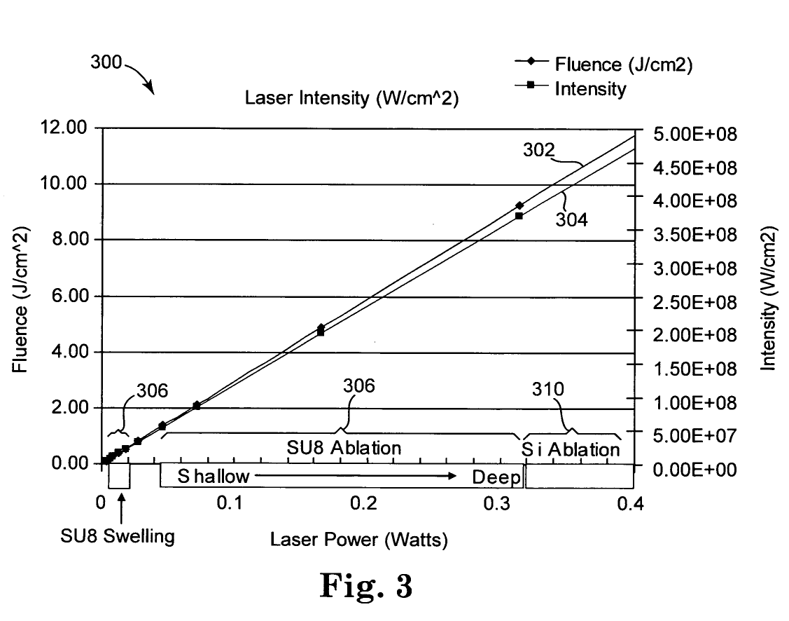

FIG. 3 is a graph 300 showing the relationship between laser power of laser 104 and the swelling and ablation of the polymer layer 204 according to one embodiment. Graph 300 represents results obtained for a laser 104 operated at 60 kHz and providing UV light at 355 nm. The left vertical axis in graph 300 represents laser fluence in J/cm² of laser 104, the right vertical axis represents laser intensity in W/cm², and the horizontal axis represents laser power in Watts of laser 104. The fluence of laser 104 is represented by curve 302, and the intensity of laser 104 is represented by curve 304.

As shown in FIG. 3, swelling of the polymer layer 204 occurs at a power range 306 of about 0.01 W to 0.02 W, which corresponds to a laser current of about 70 to 72 percent of the maximum current of laser 104. Ablation of the polymer layer 204 occurs at a power range 308 of about 0.04 W to 0.32 W, which corresponds to a laser current of about 73 to 77 percent of the maximum current of laser 104. Within the ablation range 308, as the laser power is increased, the resulting channels or cavities formed in the polymer layer become deeper and deeper. The penetration depth is also dependent on the laser wavelength and the absorption of the material being ablated. The higher the absorption coefficient of the material being ablated, the less penetration depth at a given wavelength. Thus, there is a tradeoff between ablation efficiency and wavelength, which is material dependent.

Also shown in FIG. 3 is a power range 310, which is the ablation range for silicon. Ablation of silicon occurs at a power range 308 of about 0.32 W to 0.4 W, which corresponds to a laser current of about 77 to 81 percent of the maximum current of laser 104. Since the ablation range 310 for silicon is higher than the ablation range 308 for the polymer layer 204, when the polymer layer 204 is formed on an underlying silicon layer, the polymer layer 204 may be patterned without adversely affecting the underlying silicon layer. By controlling the laser power and cut speed (i.e., the speed at which the laser beam is scanned across the substrate 112), polymer layer 204 can be patterned without damaging such an underlying silicon layer, or without damaging other underlying layers, such as metal material substrates (e.g., stainless steel, nickel, gold). Although some example underlying materials have been mentioned herein, it will be understood that the polymer layer 204 can be patterned on any underlying material with an ablation threshold that is greater than the polymer layer 204.

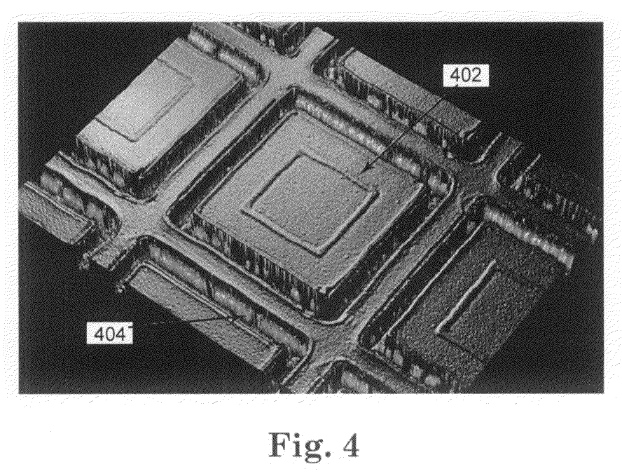

FIG. 4 is a Wyko white light interferometry image of a polymer layer 204 with raised features 402 and cavity features 404 formed by the system 100 shown in FIG. 1 according to one embodiment. The raised features 402 are formed as described above by using laser energies below the ablation threshold of the polymer layer 204, and the cavity features 404 are formed by using laser energies at or above the ablation threshold of the polymer layer 204. In the illustrated embodiment, the cavity features 404 are 5 micrometer deep microchannels or microtrenches, and the raised features 402 are 0.1 micrometers high. In one embodiment, system 100 is configured to create cavity features that are about 0.5 to 50 micrometers wide (i.e., line width) and about zero to several hundred micrometers deep, and is configured to create raised features that are about 0.2 to 20 micrometers wide and about zero to a few micrometers high.

One embodiment of system 100 provides direct write patterning of a polymer layer 204 with a process that can be accomplished at low temperatures (e.g., less than 150° C.). The ability to selectively write 3 D structures in a polymer layer 204 provided by system 100 is advantageous to creating customized templated patterns for micro electromechanical systems (MEMS) and macroelectronic applications. One embodiment of system 100 is configured to create 3 D structures in a substrate 112 with fewer and less expensive processing steps compared to traditional photolithographic processes. The patterning process according to one embodiment may also be used in conjunction with other process steps where additional coating layers are not a solution. For example, if the substrate 112 is patterned via a first process, but requires a raised feature, system 100 can provide the raised feature without the need of an additional coating layer being deposited. In one embodiment, system 100 is configured to use direct write patterning to form contact pads between stacked semiconductor chips. The patterning process according to one embodiment is applicable over large areas without the use of a photomask. The patterning process according to one embodiment is also capable of implementation on roll to roll type processing.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of patterning a cross-linked polymer layer, the method comprising:
providing a substrate comprising a cross-linked polymer layer;
generating a laser beam;
directing the laser beam onto a first surface of the polymer layer; and
causing relative movement between the laser beam and the first surface, thereby forming at least one feature on the first surface.

2. The method of claim 1, wherein the at least one feature comprises a raised feature that extends above the first surface.

3. The method of claim 1, wherein the at least one feature comprises a cavity feature that extends below the first surface.

4. The method of claim 1, wherein the at least one feature comprises a raised feature that extends above the first surface and a cavity feature that extends below the first surface.

5. The method of claim 4, and further comprising:
modifying a power of the laser beam to below a threshold value to cause a swelling of the polymer layer and form the raised feature; and
modifying a power of the laser beam to above the threshold value to cause ablation of the polymer layer and form the cavity feature.

6. The method of claim 1, wherein the relative movement is caused by a scanning mirror that scans the laser beam across the first surface.

7. The method of claim 1, wherein the relative movement is caused by a scanning mirror that scans the laser beam across the first surface, and a moving stage that moves the substrate.

8. The method of claim 1, wherein the laser beam comprises ultraviolet light.

9. The method of claim 8, wherein the laser beam has a wavelength of 355 nm.

10. The method of claim 1, wherein the laser beam is pulsed at 60 kHz.

11. The method of claim 1, and further comprising:
focusing the laser beam to a 1 to 100 micrometer diameter spot on the first surface.

12. The method of claim 1, wherein the cross-linked polymer layer comprises a cured SU8 negative photoresist material.

13. The method of claim 1, wherein the substrate comprises the cross-linked polymer layer formed on a silicon layer.

14. The method of claim 1, wherein the substrate comprises the cross-linked polymer layer formed on a metal layer.

15. The method of claim 14, wherein the metal layer comprises one of stainless steel, gold, and nickel.

16. The method of claim 14, wherein the substrate further comprises a silicon layer, and wherein the metal layer is formed on the silicon layer.

17. A system for patterning a cross-linked polymer layer, the system comprising:
a laser configured to generate a laser beam that is directed onto a first surface of the polymer layer;
a movement mechanism configured to cause relative movement between the laser beam and the first surface; and
a controller configured to control a power of the laser beam to selectively generate raised features and cavity features in the polymer layer.

18. The system of claim 17, wherein the cross-linked polymer layer comprises a cured SU8 negative photoresist material.

19. A substrate comprising:
a substrate layer;
a cross-linked polymer layer formed on the substrate layer; and
wherein the cross-linked polymer layer includes at least one cavity and at least one raised feature, and wherein the features are formed by scanning a laser beam over a surface of the cross-linked polymer layer.

20. The substrate of claim 19, wherein the cross-linked polymer layer comprises a cured SU8 negative photoresist material.
